(19) United States
(12) Patent Application Publication
(10) Pub. No.: US 2013/0322515 A1
(43) Pub. Date: Dec. 5, 2013

(54) Data transmission System and Method

(71) Applicant: NOVATEK MICROELECTRONICS CORP., Hsin-Chu (TW)

(72) Inventors: Chia-Hsin Tung, Hsinchu City (TW); Jia-Jye Shyu, Hsinchu City (TW)

(73) Assignee: NOVATEK MICROELECTRONICS CORP., Hsin-Chu (TW)

(21) Appl. No.: 13/686,925

(22) Filed: Nov. 28, 2012

(30) Foreign Application Priority Data
May 31, 2012 (TW) 101119502

(51) Int. Cl. H04N 7/26

(52) U.S. Cl. CPC H04N 19/00
USPC 375/240.01

(57) ABSTRACT

A data transmission system includes a transmission device having a first control module for generating a first control signal. A first transformation module is coupled to the first control module for transforming an original data into a transmission data according to the original data and the first control signal. A multiplexer is utilized for transmitting the transmission data according to the first control signal. A reception device includes a second control module for generating a second control signal, a reception module coupled to the second control module for receiving the transmission data, and a second transformation module for transforming the transmission data into the original data according to the second control signal, so as to transmit the original data to a display device. Thus, a transmission size of the transmission data is smaller than a transmission size of the original data.

### BACKGROUND OF THE INVENTION

1. Field of the Invention

The present invention relates to data transmission system and method thereof, and more particularly, to a data transmission system and method thereof for transmitting a compressed data between a transmission device and a reception device.

2. Description of the Prior Art

In tradition, a liquid crystal display (LCD) driving chip as a reception end receives an uncompressed image data from a processor as a transmission end. However, due to higher resolutions of modern LCDs, more transmission sizes of the image data are anticipated. Thus, a bit rate for transmission between the processor and the LCD driving chip has been required to increase more, and power consumption shall be increased at the reception end or the transmission end as well. If the image data is operated with a line base compression to effectively reduce the required bit rate for transmission between the processor and the LCD driving chip such that the same transmission accuracy can be maintained, the following operation where the LCD driving chip re-transforms the image data or processes another update operation for the image data might be difficult.

Therefore, it has become an important issue to provide a data transmission system and method thereof for transmitting a compressed data between the transmission end and the reception end, so as to utilize a lower bit rate for transmission accompanying higher transmission accuracy and to improve processing efficiency of the LCD driving chip.

### SUMMARY OF THE INVENTION

It is therefore an objective of the invention to provide a data transmission system and method thereof for transmitting a compressed data between a transmission device and a reception device.

The present invention discloses a data transmission system comprising a transmission device having a first control module for generating a first control signal, a first transformation module coupled to the first control module for transforming an original data into a transmission data according to the original data and the first control signal, and a multiplexer coupled to the first control module and the first transformation module for transmitting the transmission data according to the first control signal. The transmission system further includes a reception device comprising a second control module for generating a second control signal, a reception module coupled to the second control module for receiving the transmission data, and a second transformation module coupled to the reception module and the second control module for transforming the transmission data into the original data according to the second control signal, so as to transmit the original data to a display device, wherein a transmission size of the transmission data is smaller than a transmission size of the original data.

The present invention also discloses another method for a data transmission system comprising generating a first control signal and a second control signal, transforming an original data into a transmission data according to the original data and the first control signal, transmitting the transmission data according to the first control signal, receiving the transmission data, and transforming the transmission data into the original data according to the second control signal, so as to transmit the original data to a display device, wherein a transmission size of the transmission data is smaller than a transmission size of the original data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a data transmission system according to an embodiment of the invention.

FIG. 2 illustrates a detailed schematic diagram of the transmission device in FIG. 1 according to an embodiment of the invention.

FIG. 3 illustrates a detailed schematic diagram of the encoding module of the first transformation module shown in FIG. 2 according to an embodiment of the invention.

FIG. 4 illustrates a detailed schematic diagram of the reception module in FIG. 2 according to an embodiment of the invention.

FIG. 5 is the schematic diagram of operation of the original data being transformed into the transmission data according to an embodiment of the invention.

FIG. 6 is the schematic diagram of the transmission data being transformed into the original data according to an embodiment of the invention.

FIG. 7 illustrates a schematic diagram of a transmission period for the original data being transformed into the transmission data according to an embodiment of the invention.

FIG. 8 illustrates another schematic diagram of a transmission period for the original data being transformed into the transmission data according to an embodiment of the invention.

FIG. 9 illustrates a schematic diagram of a packet format of transmission data shown in FIG. 7.

FIG. 10 illustrates a flow chart of a data transmission process according to an embodiment of the invention.

### DETAILED DESCRIPTION

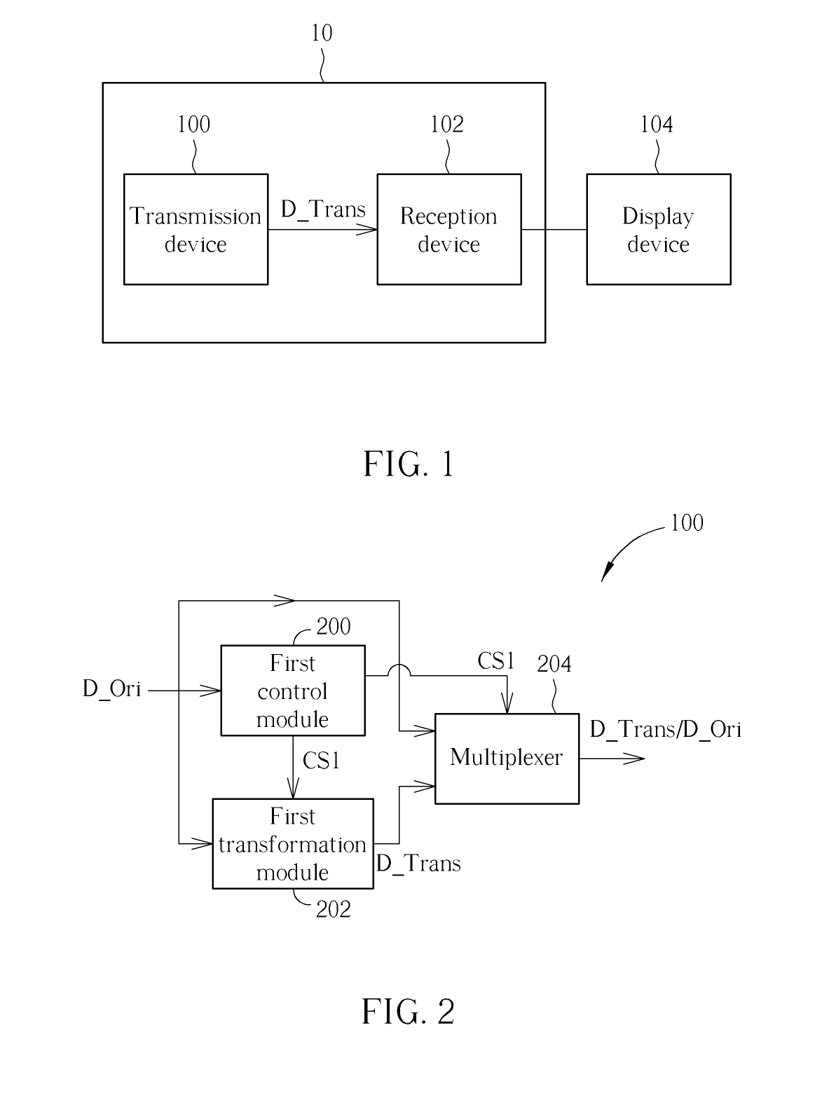

Please refer to FIG. 1, which illustrates a schematic diagram of a data transmission system 10 according to an embodiment of the invention. As shown in FIG. 1, the data transmission system 10 is utilized in the Mobile industry processor interface (MIPI) and includes a transmission device 100 and a reception device 102. The transmission device 100 is a baseband chip or a processor to transform an original data (not shown in the figure) into a transmission data D_Trans to be transmitted to the reception device 102 according to a user's requirements/commands. The reception device 102 is a liquid crystal display driving chip to transform the transmission data D_Trans into the original data again to be transmitted to a display device 104 for displaying. Preferably, the original data and the transmission data D_Trans correspond to an image data, and the transmission data D_Trans is operated via a compression operation, such as a block base compression, such that a transmission size of the transmission data D_Trans is smaller than a transmission size of the original data. A lower bit rate for transmission accompanying higher transmission accuracy can be provided and processing efficiency of the LCD driving chip can be improved.

Noticeably, the embodiment of the invention mainly focuses on the reception device 102 coupled to the display device 104. Certainly, the reception device 102 can be integrated with the display device 104 within the same device for transformation of the transmission data D_Trans into the original data D_Trans and a display operation of the original data. Besides, the transmission device 100 or the reception device 102 can be realized via a camera device or other electronic devices demanding higher resolutions complying with the MIPI, which is also in the scope of the invention.

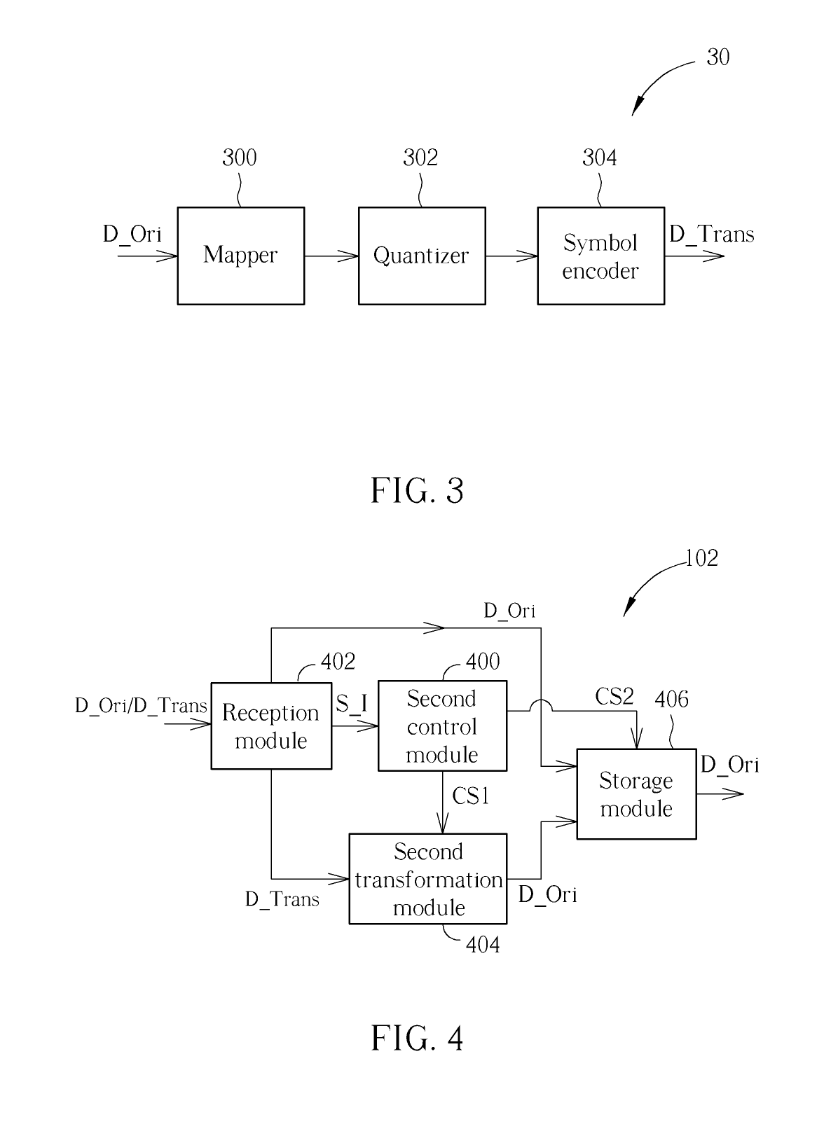

Please refer to FIG. 2, which illustrates a detailed schematic diagram of the transmission device 100 in FIG. 1 according to an embodiment of the invention. As shown in FIG. 2, the transmission device 100 includes a first control module 200, a first transformation module 202 and a multiplexer 204. In the embodiment, the original data D_Ori is generated via a processor (not shown in the figure) inside the transmission device 100, or via another processor outside the transmission device 100, which is not limiting the scope of the invention. After the transmission device 100 receives the original data D_Ori, the original data D_Ori is transmitted to the first control module 200, the first transformation module 202 and the multiplexer 204. The first control module 200 generates a first control signal CS1 while receiving the original data D_Ori. The first transformation module 202 includes an encoding module 30, as shown in FIG. 3. When the first transformation module 202 receives the original data D_Ori, the encoding module 30 compresses the original data D_Ori to be the transmission data D_Trans according to the first control signal CS1. The multiplexer 204 receives the original data D_Ori and the transmission data D_Trans at the same time. Accordingly, the multiplexer 204 can output either the transmission data D_Trans or the original data D_Ori to the reception device 102 according to the first control signal CS1, or the multiplexer 204 can output both the transmission data D_Trans and the original data D_Ori as well.

As shown in FIG. 3, the encoding module processes a block base compression being well known to those skilled in the art. Preferably, the encoding module 30 includes a mapper 300, a quantizer 302 and a symbol encoder 304. The mapper 300 is utilized for processing a mapping operation to reduce an interpixel redundancy of the original data D_Ori. The quantizer 302 is utilized for processing a quantization operation to reduce a psychovisual redundancy of the original data D_Ori. The symbol encoder 304 is utilized for processing an encoding operation to reduce an encoding redundancy of the original data D_Ori. According to different users' requirements, the block base operation can be adaptively modified to be combined with the conventional line base compression or the conventional frame base compression, so as to provide the users different transmission bit rates and processing efficiencies, which is also in the scope of the invention.

After the encoding module 30 of the transmission device 100 finishes the compression of the original data D_Ori and the transmission data D_Trans, the original data D_Ori and the transmission data D_Trans are transmitted from the transmission device 100 to the reception device 102. Please refer to FIG. 4, which illustrates a detailed schematic diagram of the reception module 102 in FIG. 2 according to an embodiment of the invention. As shown in FIG. 4, the reception module 102 includes a second control module 400, a reception module 402, a second transformation module 404 and a storage module 406. According to different requirements, the reception module 402 can be utilized to receive the original data D_Ori, the transmission data D_Trans or their combination. In the embodiment, the reception module 402 simultaneously receives the original data D_Ori and the transmission data D_Trans, and generates a reception result S_I to be transmitted to the second control module 400. Accordingly, the second control module 400 generates a second control signal CS2. Besides, the reception module 402 transmits the original data D_Ori to the storage module 406, and transmits the transmission data D_Trans to the second transformation module 404. The second transformation module 404 is utilized to transform the transmission data D_Trans into the original data D_Ori according to the second control signal CS2, so as to transmit the original data D_Ori to the storage module 406 as well. Preferably, the second transformation module 404 further includes a decoding module not shown in the figure for a reverse operation similar to the transformation of the original data D_Ori into the transmission data D_Trans, so as to transform the transmission data D_Trans into the original data D_Ori again. The reverse operation via the decoding module can be referenced from the above compression, and is not the motivation of the invention to be described hereinafter. The storage module 406 is utilized to store the original data D_Ori from the reception module 402 or from the second transformation module 404, and outputs the original data D_Ori to the display device 104 according to the second control signal CS2. In the embodiment, the reception module 402 and the storage module 406 are both controlled via the second control signal CS2 to instantaneously display the original data D_Ori on the display device 104. Certainly, those skilled in the art can utilize different control signals to control the mechanism for transforming the transmission data D_Trans into the original data D_Ori and displaying the original data D_Ori on the display device 104, which is not limiting the scope of the invention.

In simple, the data transmission system 10 utilizes the transmission device 100 to compress the original data D_Ori to be the transmission data D_Trans, so as to obtain the smaller transmission size of the transmission data D_Trans. Next, the reception device 102 transforms the transmission data D_Trans into the original data D_Ori to be displayed on the display device 104. Preferably, the transmission between the transmission device 100 and the reception device 102 can be realized via a wired transmission line or the electromagnetic wave, which is also in the scope of the invention.

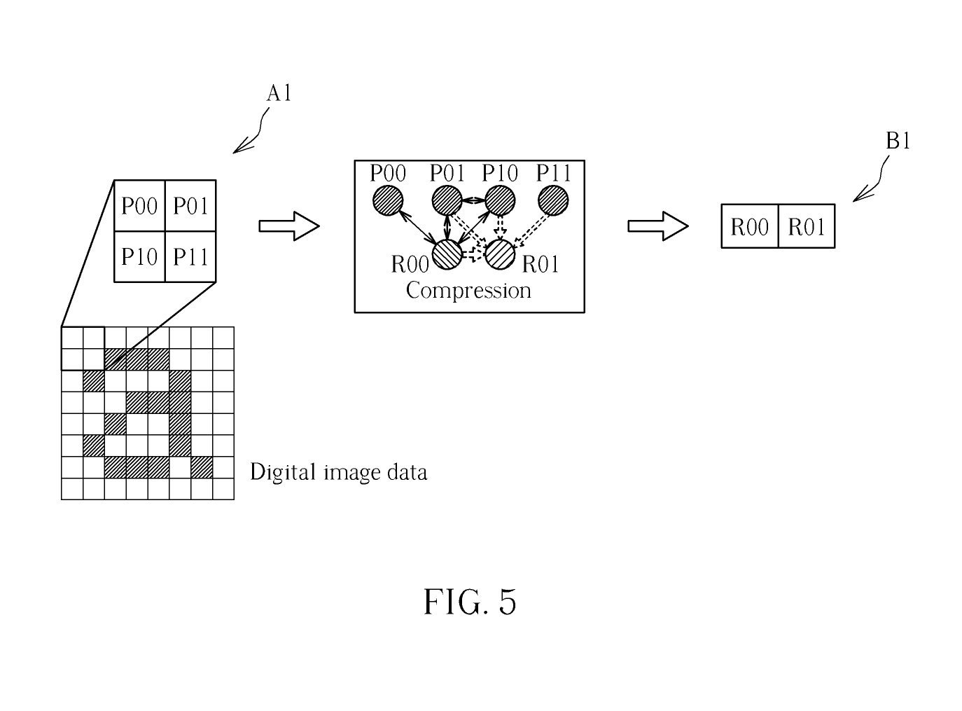

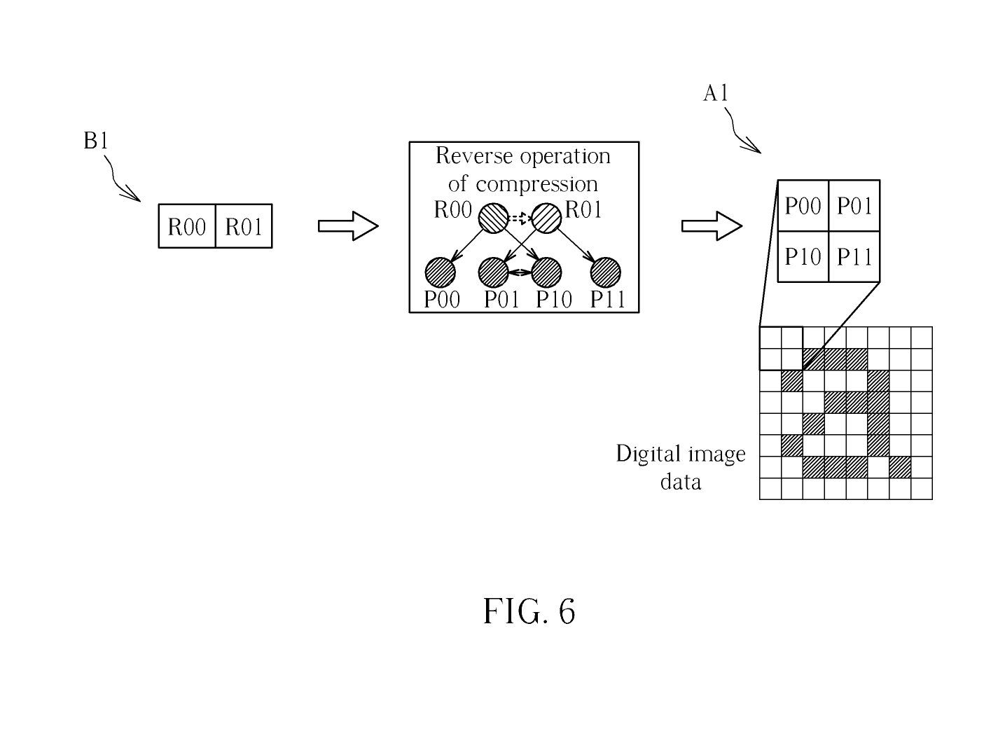

For example, please refer to FIG. 5 and FIG. 6, wherein FIG. 5 is the schematic diagram of operation of the original data D_Ori being transformed into the transmission data D_Trans according to an embodiment of the invention, and FIG. 6 is the schematic diagram of the transmission data D_Trans being transformed into the original data D_Ori according to an embodiment of the invention. As shown in FIG. 5, the original data D_Ori is a digital image data, such as the character “a” forming an 8×8 pixel matrix. Next, the user utilizes the transmission device 100 to compress the original data D_Ori to be another 4×8 pixel matrix forming the transmission data D_Trans, wherein 50% compression is provided. In simple, the compression is realized via the encoding module 30 of the first transformation module 202 to transform the 2×2 pixel matrix A1, circled in FIG. 5 to include pixel units P00, P01, P10, P11 into the compressed 1×2 pixel matrix B1 including pixel units R00, R01. In other words, the original data D_Ori including a plurality of pixel matrixes A1 is transformed into the transmission data D_Trans including a plurality of pixel matrixes B1. As shown in FIG. 6, in the reception module 102, one of the plurality of pixel matrixes B1 of the transmission data D_Trans is transformed into the 2×2 pixel matrix A1 via the decoding module of the second transformation module 404 to obtain the original data D_Ori, i.e. the character “a” a of the digital image data.

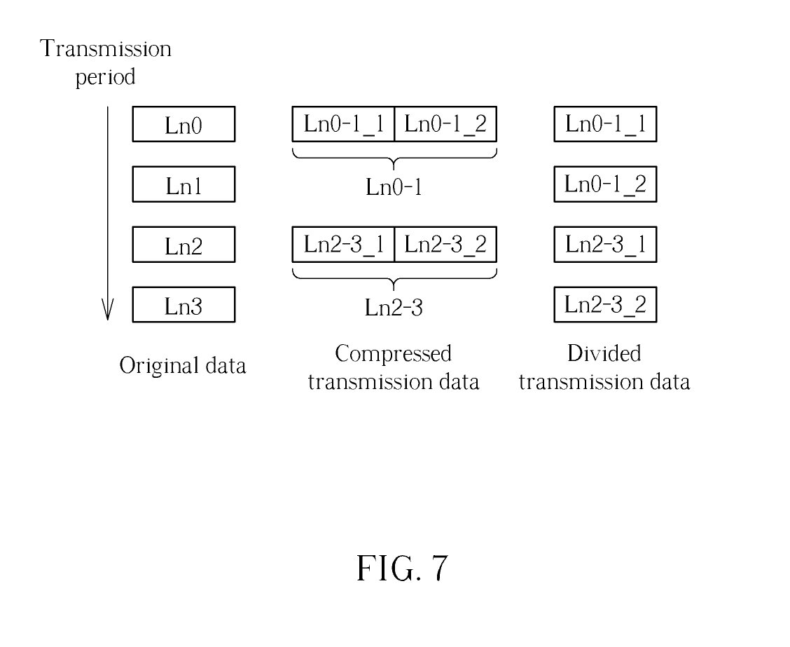

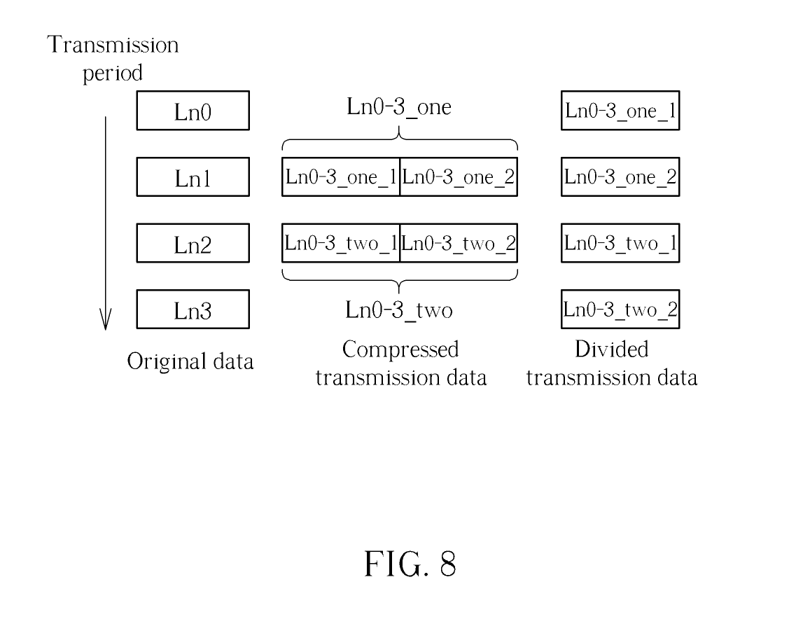

Regarding to different transmission periods, the transmission device 100 of the invention compresses all the pixel units in the Nth row and the N+1th row, e.g. both the Nth row and the N+1th row have m number of pixel units such that there are 2 m pixel units in total, to accordingly have the pixel units in the Nth row only, e.g. m number of pixel units remaining after the compression. Then, the compressed m number of pixel units in the Nth row is divided into a previous half part and a following half part, and both the previous half part and the following half part include ½ m number of pixel units to be transmitted sequentially from the transmission device 100 to the reception device 102. After the reception device 102 sequentially receives the previous half part and the following half part in the Nth row, the compressed m number of pixel units are transformed into the 2 m number of pixel units in the Nth and the N+1th rows again to be displayed sequentially on the display device 104. For example, please refer to FIG. 7, which illustrates a schematic diagram of a transmission period of the original data D_Ori being transformed into the transmission data D_Trans according to an embodiment of the invention. In the embodiment, the 2×2 pixel matrix is demonstrated for explanation, and those skilled in the art can derive another N×N pixel matrix from the conception of the embodiment, which is also in the scope of the invention. As shown in FIG. 7, the original data D_Ori includes four pixel data rows Ln0, Ln1, Ln2, Ln3. After the 50% compression provided by the transmission device 100, two pixel data rows Ln0-1 and Ln2-3 remains. Then, the two pixel data rows Ln0-1 and Ln2-3 are divided to have previous half parts Ln0-1_{—}1, Ln2-3_{—}1 and following half parts Ln0-1_{—}2, Ln2-3_{—}2 to be transmitted sequentially from the transmission device 100 to the reception device 102. The operation of the reception device 102 can be obtained from the reverse compression of the transmission device 100, and is not described hereinafter. Please refer to FIG. 8, which illustrates another schematic diagram of a transmission period for the original data D_Ori being transformed into the transmission data D_Trans according to an embodiment of the invention. In comparison with FIG. 7, the embodiment shown in FIG. 8 utilizes a 4×4 pixel matrix for compression demonstration. Four pixel data rows Ln0, Ln1, Ln2, Ln3 of the original data D_Ori are compressed to be two pixel data rows Ln0-3_one, Ln0-3_two with 50% compression as well. Then, the two pixel data rows Ln0-3_one, Ln0-3_two are divided to be the previous half parts Ln0-3_one_{—}1, Ln0-3_two_{—}1 and the following half parts Ln0-3_one_{—}2 and Ln0-3_two_{—}2 to be transmitted from the transmission device 100 to the reception device 102. The 50% compression operation provided in the above embodiment is only for demonstration, which is not limiting the scope of the invention.

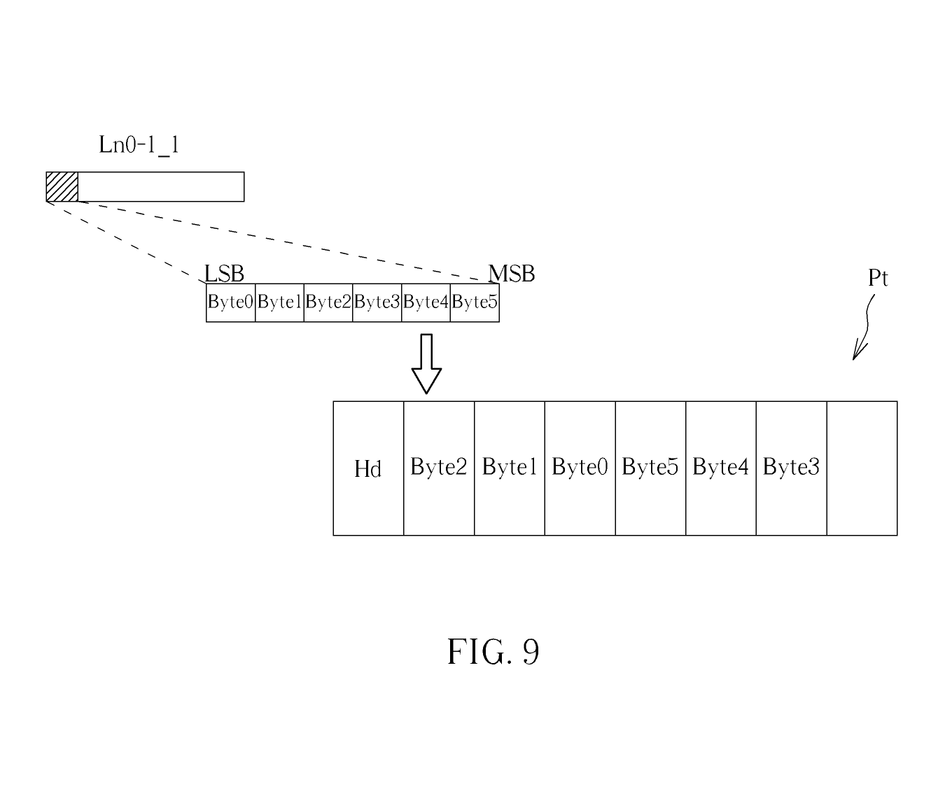

Noticeably, the data transmission system 10 is operated under the MIPI to process the image data transmission between the transmission device 100 and the reception device 102. If the reception device includes the storage device 406, a command mode transmission is operated between the transmission device 100 and the reception device 102, as shown in FIG. 4, wherein a 39h packet format is utilized in the command mode transmission. If the reception device does not include the storage device 406, a video mode transmission is operated between the transmission device 100 and the reception device 102, wherein packet formats as 0Eh, 1Eh, 2Eh or 3Eh are utilized in the video mode transmission. Both are in the scope of the invention. Please refer to FIG. 9, which illustrates a schematic diagram of a packet format of transmission data D_Trans shown in FIG. 7. As shown in FIG. 9, the pixel unit Ln0-1_{—}1 of the compressed transmission data D_Trans includes 48 bits, i.e. there are six byte sets Byte 0-6, to form a transmission packet Pt having a header Hd. Additionally, the six byte sets Byte 0-6 can be randomly arranged according to different users' requirements, and a packet format as 0X3E packed pixel stream long packet is demonstrated hereinafter, which is not limiting the scope of the invention.

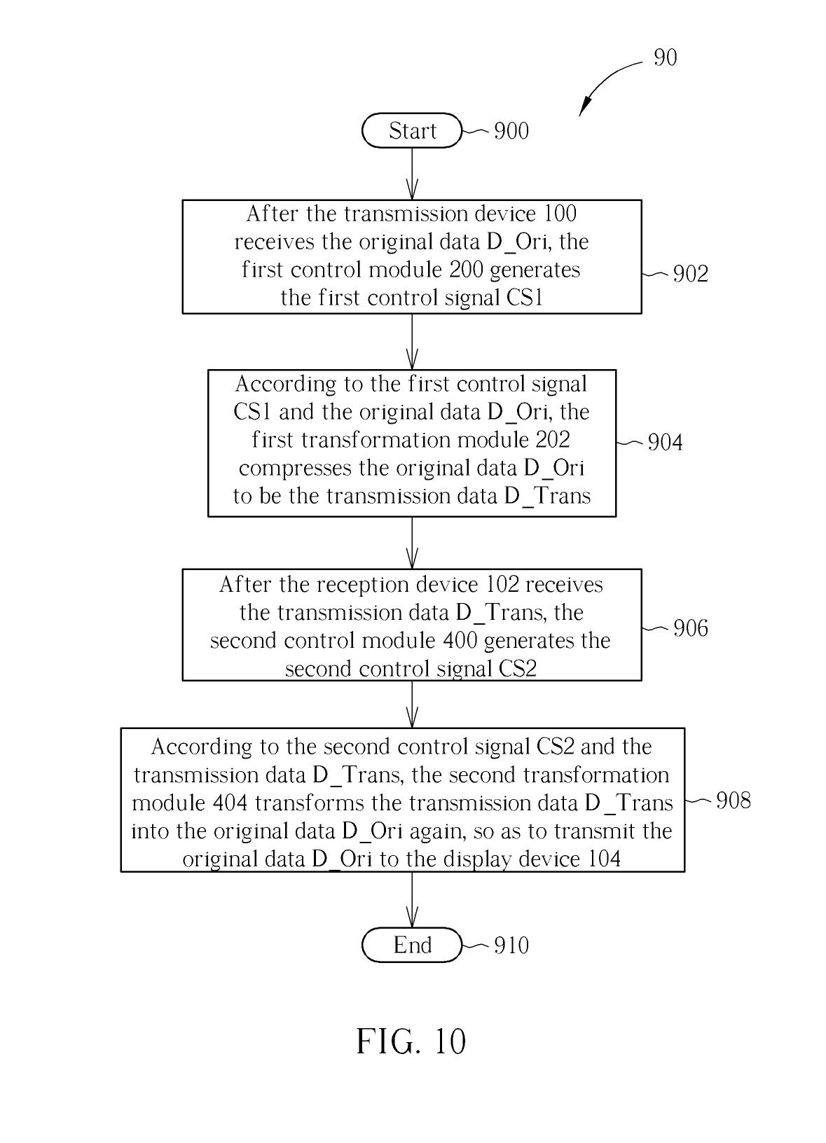

In the embodiment of the invention via the wired/wireless transmission, a data transmission method applied to the data transmission system 10 can be summarized as a data transmission process 90, as shown in FIG. 10. The data transmission process 90 includes the steps as follows:

Step 900: Start.

Step 902: After the transmission device 100 receives the original data D_Ori, the first control module 200 generates the first control signal CS1.

Step 904: According to the first control signal CS1 and the original data D_Ori, the first transformation module 202 compresses the original data D_Ori to be the transmission data D_Trans.

Step 906: After the reception device 102 receives the transmission data D_Trans, the second control module 400 generates the second control signal CS2.

Step 908: According to the second control signal CS2 and the transmission data D_Trans, the second transformation module 404 transforms the transmission data D_Trans into the original data D_Ori again, so as to transmit the original data D_Ori to the display device 104.

Step 910: End.

The detailed steps of the data transmission process 90 can be understood via the related paragraphs of the above embodiments and FIG. 1 to FIG. 9, and are not described hereinafter. Noticeably, step 906 can be simultaneously operated to receive the original data D_Ori and the transmission data D_Trans, and step 908 can be operated via the second control signal CS2 to transmit the original data D_Ori stored inside the storage device 406 to the display device 104. Under such circumstances, the transmission device 100 and the reception device 102 can transform the original data D_Ori into the transmission data D_Trans in advance via the data transmission process 90 to lower the transmission bit rate as well as to maintain higher transmission accuracy. For the sake of reception device 102, the transmission data D_Trans is in advance transformed into the original data D_Ori, which improves the processing efficiency of the LCD driving chip and reduces the power consumption thereof.

In summary, the embodiments of the invention provides a data transmission system which processes a compression operation, such as a block base compression, to compress an original data to be a transmission data, which provides a transmission size of the transmission data smaller than a transmission size of the original data. Under such circumstances, the transmission bit rate of the embodiment does not need to increase. Instead, a slower transmission bit rate with higher transmission accuracy can be operated in the embodiment. In the reception device, transformation of the transmission data into the original data can be provided to a LCD driving chip for higher image processing efficiency. Also, the embodiment of the invention can be applied to an electronic device complied with the MIPI to be utilized in the command mode transmission or the video mode transmission, so as to broaden the product application of the data transmission system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission system comprising:
a transmission device comprising:
a first control module for generating a first control signal;
a first transformation module coupled to the first control module for transforming an original data into a transmission data according to the original data and the first control signal; and
a multiplexer coupled to the first control module and the first transformation module for transmitting the transmission data according to the first control signal; and
a reception device comprising:
a second control module for generating a second control signal;
a reception module coupled to the second control module for receiving the transmission data; and
a second transformation module coupled to the reception module and the second control module for transforming the transmission data into the original data according to the second control signal, so as to transmit the original data to a display device;
wherein a transmission size of the transmission data is smaller than a transmission size of the original data.

2. The data transmission system of claim 1, wherein the original data comprises 2N data rows and the transmission data comprises N data rows.

3. The data transmission system of claim 2, wherein the first transformation module further comprises an encoding module for transforming the 2N data rows of the original data into the N data rows of the transmission data to be transmitted to the reception module of the reception device.

4. The data transmission system of claim 3, wherein the original data comprises at least a first data row and a second data row, and the encoding module compresses the first data row and the second data row to be a first encoding data row to be transmitted to the reception module of the reception device of the reception device.

5. The data transmission system of claim 3, wherein the original data comprises at least a first data row, a second data row, a third data row and a fourth data row, and the encoding module compresses the first data row, the second data row, the third data row and the fourth data row to be a first encoding data row and a second encoding data row, so as to be transmitted to the reception module of the reception device.

6. The data transmission system of claim 3, wherein the original data is a digital image data.

7. The data transmission system of claim 6, wherein the encoding module further comprises a mapper for processing a mapping operation to reduce an interpixel redundancy of the original data.

8. The data transmission system of claim 7, wherein the encoding module further comprises a quantizer coupled to the mapper for processing a quantization operation to reduce a psychovisual redundancy of the original data.

9. The data transmission system of claim 8, wherein the encoding module further comprises a symbol encoder coupled to the quantizer for processing an encoding operation to reduce an encoding redundancy of the original data.

10. The data transmission system of claim 1, wherein the reception module further comprises a storage module for storing the transmission data according to the second control data.

11. The data transmission system of claim 10, wherein the transmission device further transmits the original data to the storage module of the reception device, and the storage module correspondingly transmits the original data to the display device according to the second control signal.

12. The data transmission system of claim 1, wherein the second transformation module further comprises a decoding module for transforming the transmission data into the original data to be transmitted to the display device according to the second control data.

13. The data transmission system of claim 1, wherein a video mode transmission or a command mode transmission of the Mobile Industry Processor Interface (MIPI) is utilized to transmit the original data to the display device.

14. The data transmission system of claim 13, wherein the transmission data corresponds to a packet format as 39h in the command mode transmission.

15. The data transmission system of claim 13, wherein the transmission data corresponds to a packet format as 0Eh, 1Eh, 2Eh or 3Eh in the video mode transmission.

16. The data transmission system of claim 1, wherein the transmission device further utilizes a 0X3E packed pixel stream long packet to transmit the transmission data.

17. The data transmission system of claim 1, wherein the transmission device is a baseband chip.

18. The data transmission system of claim 1, wherein the reception device is a liquid crystal display chip.

19. The data transmission system of claim 1, wherein the transmission device further processes a block base compression operation.

20. A method for a data transmission system comprising:
generating a first control signal and a second control signal;
transforming an original data into a transmission data according to the original data and the first control signal;
transmitting the transmission data according to the first control signal;
receiving the transmission data; and
transforming the transmission data into the original data according to the second control signal, so as to transmit the original data to a display device;
wherein a transmission size of the transmission data is smaller than a transmission size of the original data.

21. The method of claim 20, wherein the original data comprises 2N data rows and the transmission data comprises N data rows.

22. The method of claim 21, further utilizing an encoding module for compresses the 2N data rows of the original data to be the N data rows of the transmission data.

23. The method of claim 22, wherein the original data comprises at least a first data row and a second data row, and the encoding module compresses the first data row and the second data row to be a first encoding data row.

24. The method of claim 22, wherein the original data comprises at least a first data row, a second data row, a third data row and a fourth data row, and the encoding module compresses the first data row, the second data row, the third data row and the fourth data row to be a first encoding data row and a second encoding data row.

25. The method of claim 22, wherein the original data is a digital image data.

26. The method of claim 25, further utilizing a mapper for processing a mapping operation to reduce an interpixel redundancy of the original data.

27. The method of claim 26, further utilizing a quantizer coupled to the mapper for processing a quantization operation to reduce a psychovisual redundancy of the original data.

28. The method of claim 27, further utilizing a symbol encoder coupled to the quantizer for processing an encoding operation to reduce an encoding redundancy of the original data.

29. The method of claim 20, further utilizing a storage module for storing the transmission data according to the second control data.

30. The method of claim 29, further comprising transmitting the original data to the storage module, and the storage module correspondingly transmitting the original data to the display device according to the second control signal.

31. The method of claim 20, further utilizing a decoding module for transforming the transmission data into the original data to be transmitted to the display device according to the second control data.

32. The method of claim 20, further utilizing a video mode transmission or a command mode transmission of the Mobile Industry Processor Interface (MIPI) to transmit the original data to the display device.

33. The method of claim 32, wherein the transmission data corresponds to a packet format as 39h in the command mode transmission.

34. The method of claim 32, wherein the transmission data corresponds to a packet format as 0Eh, 1Eh, 2Eh or 3Eh in the video mode transmission.

35. The method of claim 20, further utilizing a 0X3E packed pixel stream long packet to transmit the transmission data.

36. The method of claim 20, further being utilized between a baseband chip and a liquid crystal display chip.

37. The method of claim 20, further utilizing a block base compression operation.
